(19) United States
(12) Patent Application Publication
(10) Pub. No.: US 2025/0004673 A1
(43) Pub. Date: Jan. 2, 2025

(54) IMAGE FORMING APPARATUS

(71) Applicant: Toshiba Tec Kabushiki Kaisha, Tokyo (JP)

(72) Inventor: Kentaro YOSHIDA, Numazu Shizuoka (JP)

(21) Appl. No.: 18/593,422

(22) Filed: Mar. 1, 2024

(30) Foreign Application Priority Data
Jun. 27, 2023 (JP) 2023-105079

(51) Int. Cl. G06F 3/12

(52) U.S. Cl. CPC G06F 3/1208; G06F 3/1237

(57) ABSTRACT

According to one embodiment, an image forming apparatus includes a printer configured to print images on media, a tag reader-writer configured to communicate with wireless tags on the media, a communication interface to communicate with an external apparatus, and a processor. The processor is configured to receive print data via the communication interface from the external apparatus, extract a tag reader-writer command from the received print data, control the printer to print an image on a medium according to drawing data in the received print data, and control the tag reader-writer according to the extracted tag reader-writer command to perform an operation on a wireless tag on the medium.

### CROSS-REFERENCE TO RELATED APPLICATION

This application is based upon and claims the benefit of priority from Japanese Patent Application No. 2023-105079, filed Jun. 27, 2023, the entire contents of which are incorporated herein by reference.

### FIELD

Embodiments described herein relate to an image forming apparatus.

### BACKGROUND

In the related art, a digital multifunction peripheral is a known type of an image forming apparatus. Such an apparatus may include an RFID writing device that can write data to a radio frequency identification (RFID) tag provided in a medium on which an image can also be formed. The image forming apparatus including the RFID writing device writes data to the RFID tag while the medium (e.g., paper) is conveyed within the apparatus.

In the related art, the image forming apparatus provided with the RFID writing device acquires both print data corresponding to the image to be printed on the medium and the data to be written to the RFID tag. As a result, occasionally, a mismatching may occur in the association between the image printed on the medium and the data written to the RFID tag. Therefore, there is a demand for an image forming apparatus in which mismatching between the image and RFID tag can be avoided.

### BRIEF DESCRIPTION OF THE DRAWINGS

FIG. 1 depicts an image forming system including a digital multifunction peripheral according to an embodiment.

FIG. 2 is an external view of a digital multifunction peripheral.

FIG. 3 is a cross-sectional schematic view of a digital multifunction peripheral.

FIG. 4 is a block diagram of a control system in a digital multifunction peripheral.

FIG. 5 is a block diagram of a control system in a terminal apparatus that can be connected to an image forming apparatus.

FIG. 6 is a diagram illustrating an example of print data that is supplied to a digital multifunction peripheral.

FIG. 7 is an example of a table in which drawing (image) data for different pages is associated with a RFID command that was included in print data supplied to a digital multifunction peripheral.

FIG. 8 is a flowchart of a process for generating print data incorporating an RFID command as performed by a terminal apparatus.

FIG. 9 is a flowchart of processing of print data including a RFID command as performed by a digital multifunction peripheral.

### DETAILED DESCRIPTION

In general, according to one embodiment, an image forming apparatus includes a printer configured to print images on media, a tag reader-writer configured to communicate with wireless tags on the media, a communication interface configured to communicate with an external apparatus, and a processor. The processor is configured to receive print data via the communication interface from the external apparatus, extract a tag reader-writer command from the received print data, control the printer to print an image on a medium according to drawing data in the received print data, and control the tag reader-writer according to the extracted tag reader-writer command to perform an operation on a wireless tag on the medium.

Hereinafter, certain example embodiments will be described with reference to the drawings.

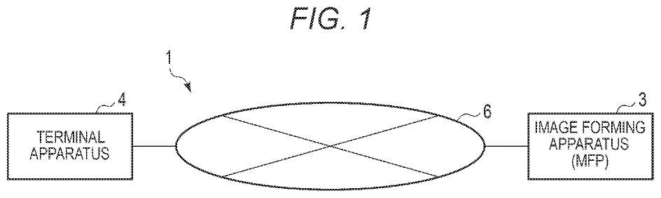

First, a configuration of an image forming system 1 according to an embodiment will be described. FIG. 1 is a diagram schematically illustrating an image forming system 1 according to an embodiment.

As illustrated in FIG. 1, in the image forming system 1, a digital multifunction peripheral (MFP) 3 (an image forming apparatus) is connected to a terminal apparatus 4 via a network 6.

The digital multifunction peripheral 3 is an example of an image forming apparatus that can be placed at a workplace or the like. The digital multifunction peripheral 3 performs processes according to commands supplied thereto. For example, the digital multifunction peripheral includes a printer that prints an image on a medium, such as a sheet of paper or label with a wireless tag or the like embedded therein or affixed thereto. In the present embodiment, the wireless tag is an RFID tag. Note that the wireless tag is not limited to a RFID tag, and any device that may be embedded/affixed to the medium then written with data/information may be employed.

The digital multifunction peripheral 3 processes a medium including an RFID tag. The digital multifunction peripheral 3 prints an image on the medium and executes an RFID-related command process on the RFID tag of the medium. In this instance, data is written to the RFID tag after the image has been printed on the medium with the RFID tag. For example, the digital multifunction peripheral 3 writes RFID data corresponding to, or associated with, the printed image to the RFID tag in response to a write command.

The terminal apparatus 4 is an information processing apparatus that is operated by a user or the like. The terminal apparatus 4 can be an information processing apparatus, such as a personal computer (PC) or a portable terminal (tablet terminal or a smartphone). The terminal apparatus 4 communicates with the digital multifunction peripheral 3 via the network 6. In the image forming system 1, a plurality of terminal apparatuses 4 may be connected to the network 6. In the present example, the terminal apparatus 4 is an apparatus that transmits print data to the digital multifunction peripheral 3. The transmitted print data includes image data for printing and content for the RFID tag writing or processing.

Next, the configuration of the digital multifunction peripheral 3 according to the embodiment will be described.

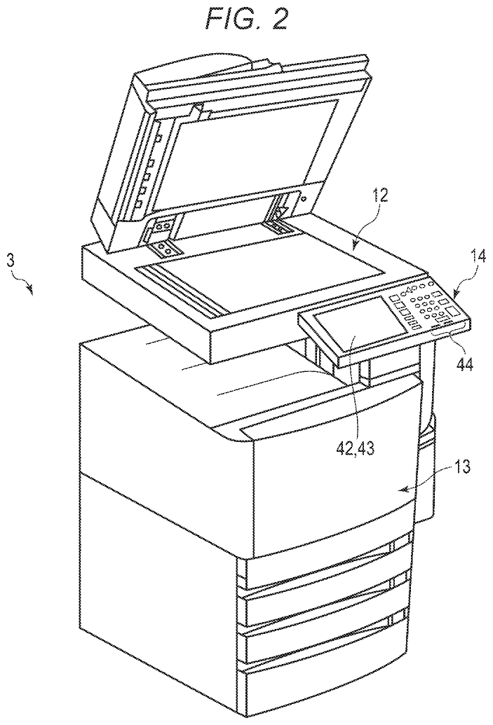

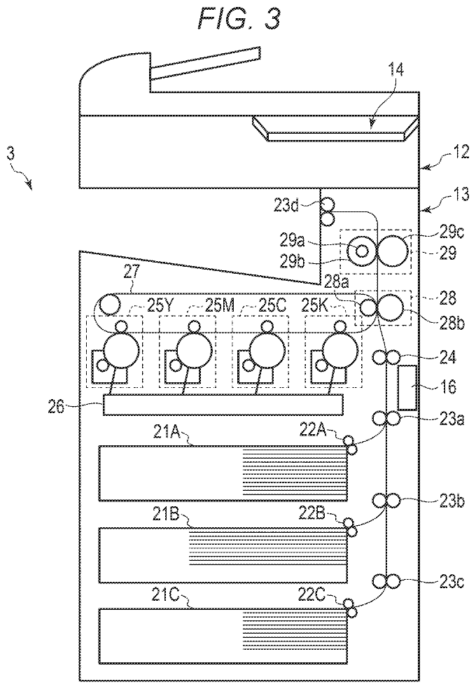

FIG. 2 is a perspective view illustrating an external configuration example of the digital multifunction peripheral 3 according to the embodiment. FIG. 3 is a schematic cross-sectional view of a digital multifunction peripheral 3 according to the embodiment.

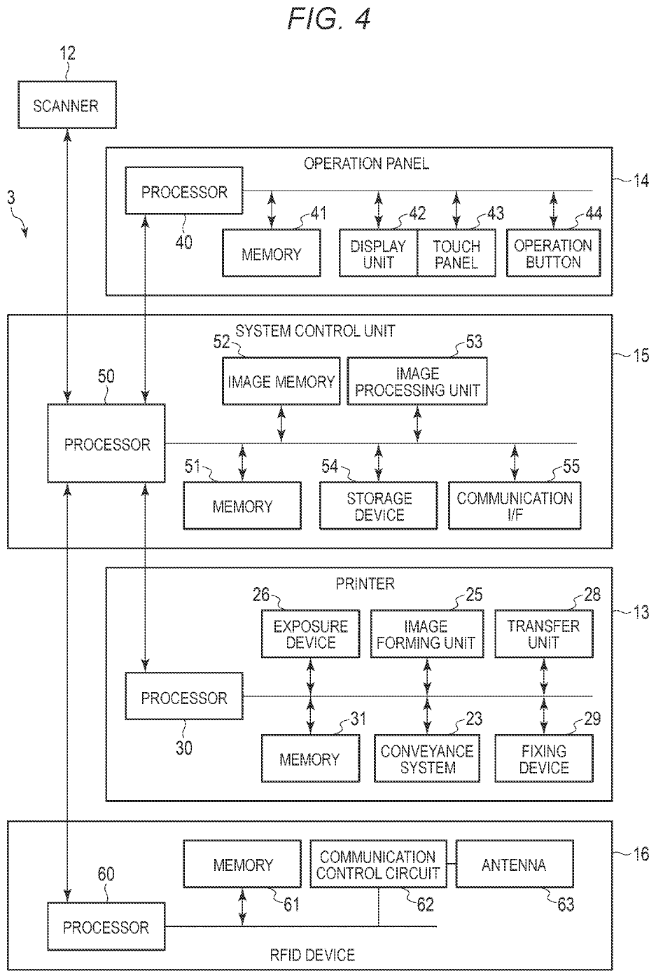

As illustrated in FIG. 2, the digital multifunction peripheral 3 has a scanner 12, a printer 13, and an operation panel 14. Furthermore, the digital multifunction peripheral 3 has, inside a housing, a system control unit 15 (see FIG. 4) and an RFID device 16 (RFID reader-writer).

The scanner 12 is provided in a main body upper portion of the digital multifunction peripheral 3. The scanner 12 is an apparatus that optically reads an image on a document. The scanner 12 has a platen glass on which a document to be scanned can be placed. The scanner 12 has an image reading mechanism for scanning the document on the platen glass. The image reading mechanism of the scanner 12 is configured with a carriage, a photoelectric conversion unit, and the like provided below the platen glass. The scanner 12 may include an auto document feeder (ADF).

The printer 13 (image forming mechanism) has paper feed cassettes 21A, 21B, and 21C. The paper feed cassettes 21A, 21B, and 21C store media, such as paper, to be processed. The media stored in the paper feed cassettes 21A, 21B, and 21C can be carried by a conveyance system. For example, each of the paper feed cassettes 21A, 21B, and 21C can be attached to and detached from a lower portion of the digital multifunction peripheral main body. The paper feed cassettes 21A, 21B, and 21C have paper feed rollers 22A, 22B, and 22C, respectively. Each of the paper feed rollers 22A, 22B, and 22C picks up paper (media) from each of the paper feed cassettes 21A, 21B, and 21C one by one. In the embodiment, a medium including RFID tags is assumed to be stored in at least one of the paper feed cassettes 21A, 21B, and 21C.

A conveyance system 23 (conveyance mechanism) conveys the medium (hereinafter, referred to as paper) in the printer 13. The conveyance system 23 includes conveyance rollers 23a to 23d, a registration roller 24, and the like. The conveyance system 23 conveys the paper picked up by the paper feed rollers 22A, 22B, and 22C to the registration roller 24. The registration roller 24 conveys the paper to a transfer position at an image transfer timing.

A plurality of image forming units 25 (25Y, 25M, 25C, 25K) form images of respective colors (yellow, magenta, cyan, black). An exposure device 26 forms electrostatic latent images on image carriers in the image forming units 25 (25Y, 25M, 25C, 25K). The exposure device 26 forms the electrostatic latent by scanning the image carriers with light emitted according to image data (the data to be printed). For example, the exposure device 26 scans the photosensitive drums in a main scanning direction and irradiates the photosensitive drums (image carriers) with light from light emitting units supplied via rotating polygon mirrors. Rotation of the photosensitive drums moves an irradiation position in a sub-scanning direction. The positions and sizes of the images formed by the image forming units 25 can be adjusted by controlling the exposure device 26.

The image forming units 25 (25Y, 25M, 25C, 25K) develop the electrostatic latent images on the image carriers with toner in the different colors (yellow, magenta, cyan, black). An intermediate transfer belt 27 is an intermediate transfer member. The image forming units 25 transfer toner images in the respective colors onto the intermediate transfer belt 27.

The intermediate transfer belt 27 holds the transferred toner images and sends toner images to a secondary transfer position. The secondary transfer position is a position where the toner images on the intermediate transfer belt 27 are transferred on the paper. The secondary transfer position is a position where a support roller 28a and a secondary transfer roller 28b face each other. The support roller 28a and the secondary transfer roller 28b configure a transfer unit 28. The registration roller 24 conveys the paper to the secondary transfer position in synchronization with the toner images being moved on the intermediate transfer belt 27. The transfer unit 28 transfers the toner images on the intermediate transfer belt 27 to the paper at the secondary transfer position.

For example, for forming a color image, the image forming units 25Y, 25M, 25C, and 25K transfer the toner images developed with toner in colors (yellow, magenta, cyan, black), respectively, to be superimposed on the intermediate transfer belt 27. The intermediate transfer belt 27 holds the color image in which the toner images in the respective colors overlap. The transfer unit 28 transfers the color image on the intermediate transfer belt 27 to the paper at the secondary transfer position. The registration roller 24 conveys the paper to the secondary transfer position in synchronization with the toner images on the intermediate transfer belt 27. Accordingly, a color image is transferred to the paper.

The transfer unit 28 feeds the paper to which the toner images have been transferred to a fixing device 29. The fixing device 29 fixes the toner images to the paper. The fixing device 29 has a heater 29a, a heat roller 29b, and a press roller 29c. The heater 29a heats the heat roller 29b. The heat roller 29b and the press roller 29c perform fixation in which the paper with the toner images transferred by the transfer unit 28 is heated in a pressed state. The heat roller 29b and the press roller 29c in the fixing device 29 send the paper subjected to fixation to the conveyance roller 23d. The conveyance roller 23d conveys the paper from the fixing device 29 to a paper discharge unit.

The operation panel 14 is a user interface. The operation panel 14 displays a guide and/or receives a user selection of an operation button or an icon. For example, the user inputs setting information via the operation panel 14. The operation panel 14 has a display unit 42 (a display), a touch panel 43, and a plurality of operation buttons 44. For example, the touch panel 43 is provided on a display screen of the display unit 42. The touch panel 43 detects a point touched by the user on the display screen of the display unit 42.

The RFID device 16 is a reader-writer that communicates with an RFID tag (also referred to as a wireless tag or an electronic tag) embedded or affixed to a medium. The RFID device 16 in this example writes data to the RFID tag and reads data from the RFID tag. The RFID device 16 is provided inside the housing of the digital multifunction peripheral 3. The RFID device 16 is used to communicate with the RFID tag on a medium being conveyed by the conveyance system 23.

The RFID device 16 is intended to communicate with the RFID tag at a predetermined communication position (within a communication range of the RFID device 16) along a conveyance path of the medium by the conveyance system 23. For example, the RFID device 16 transmits a command a predetermined write to communication position (a write position) for writing data to the The RFID device 16 may also RFID tag at the write position. transmit a read command to a predetermined communication position (a read position) for reading data from the RFID tag at the read position. The RFID device 16 is capable setting the communication range by controlling the intensity of radio waves output to the RFID tag. The RFID device 16 can check or read data that has been previously written to the RFID tag by outputting radio waves in such a manner that the entire medium after passing through the write position will be within the communication range.

In FIG. 3, the RFID device 16 communicates with the RFID tag in the medium at a position (communication position) before an image is transferred to the medium (paper). The RFID device 16 may have a configuration capable of writing data to the RFID tag in the medium conveyed by the conveyance system 23 or reading data from the RFID tag of the medium. In general, the RFID device 16 may set any position as a communication position as long as the position is on the conveyance path of the medium in the conveyance system 23. For example, the communication position for the RFID device 16 may be a position on the conveyance path after an image has been formed on the medium. In some examples, the RFID device 16 may be external equipment that can be attached and detached to and from an interface provided in the digital multifunction peripheral 3.

Next, the configuration of the control system in the digital multifunction peripheral 3 will be described.

FIG. 4 is a block diagram illustrating a control system in the digital multifunction peripheral 3.

The digital multifunction peripheral 3 has the system control unit 15 that controls the entire apparatus. The system control unit 15 is connected to the scanner 12, the printer 13, the operation panel 14, and the RFID device 16 (reader-writer). In FIG. 3, the system control unit 15 has a processor 50, a memory 51, an image memory 52, an image processing unit 53, a storage device 54, a communication interface (I/F) 55, and the like.

The processor 50 is connected to the scanner 12, a processor 30 of the printer 13, a processor 40 of the operation panel 14, and a processor 60 of the RFID device 16 via the interface. The processor 50 realizes various functions by executing a program stored in the memory 51 or the storage device 54. For example, the processor 50 executes the program stored in the memory 51, thereby outputting an operation instruction to each unit and processing various kinds of information from each unit.

The memory 51 may include a random access memory (RAM), a read only memory (ROM), and a non-volatile memory (NVM). The RAM functions as a working memory and/or a buffer memory. The ROM is a non-rewritable nonvolatile memory. The ROM functions as a program memory. The NVM is a rewritable nonvolatile memory. The NVM stores setting data and the like.

The image memory 52 stores image data. For example, the image memory 52 functions as a page memory for the image data to be processed.

The image processing unit 53 processes image data. The image processing unit 53 outputs image data obtained by executing image processing on input image data or the like. Image processing in this context may be such things as color correction, image compression or expansion. The image processing unit 53 includes a processor for performing image processing. An operating frequency (operating speed) of the processor for image processing in the image processing unit 53 is assumed to be variable in this example. That is, the image processing unit 53 is capable of changing a required image processing time by changing the operating frequency of the processor. For example, the image processing unit 53 can reduce the processing time by clocking up the operating frequency of the processor by 1.5 times or two times a baseline operating frequency.

The storage device 54 stores data, such as control data, a control program, and setting information. The storage device 54 is configured with a rewritable nonvolatile memory. For example, the storage device 54 is configured with a storage device, such as a hard disk drive (HDD) or a solid-state drive (SSD).

The storage device 54 has a scan counter and a print counter. The scan counter counts the number of pages scanned using the scanner 12. In the digital multifunction peripheral 3, the scan counter counts the number of pages scanned for each scan speed setting. The print counter counts the number of pages printed using the printer 13. In the digital multifunction peripheral 3, the print counter counts the number of pages for each print speed.

The communication I/F 55 is an interface for performing data communication with an external apparatus. For example, the communication I/F 55 is an interface that communicates with the external apparatus (an output destination) to which a scanned image scanned can be output. Furthermore, the communication I/F 55 is an interface that receives an image for printing and a print instruction from the external apparatus. Moreover, the communication I/F 55 includes an interface for transmitting FAX data generated by a FAX function to a transmission destination of the FAX. In addition, the communication I/F 55 may be an interface for communicating with an external apparatus (e.g., a server or the like) that collects the values of the scan counter and the print counter, and the like.

Next, a configuration example of a control system in the printer 13 will be described.

As illustrated in FIG. 4, the printer 13 has the processor 30, a memory 31, the conveyance system 23, the image forming units 25, the exposure device 26, the transfer unit 28, the fixing device 29, and the like.

The processor 30 realizes various functions by executing a program stored in the memory 31. For example, the processor 30 performs operation control for each unit in the printer 13, monitoring of an operation situation of each unit, and the like by executing the program. Furthermore, the processor 30 is connected to the processor 50 of the system control unit 15 via the interface. The processor 30 executes printing or the like according to an operation instruction from the system control unit 15.

The memory 31 includes a random access memory (RAM), a read only memory (ROM), and a data memory. The RAM functions as a working memory or a buffer memory. The ROM is a non-rewritable nonvolatile memory. The ROM functions as a program memory. The data memory is a rewritable nonvolatile memory.

The conveyance system 23 conveys the paper in the printer 13 under the control of the processor 30. That is, the conveyance system 23 conveys the paper by driving the conveyance rollers according to an operation instruction from the processor 30.

The exposure device 26 irradiates each of the photosensitive drums with light (laser light) for forming the electrostatic latent images on the photosensitive drums of the image forming units 25 according to an operation instruction from the processor 30. The processor 30 adjusts a printing position, an image scaling, and the like by controlling positions where the exposure device 26 irradiates the photosensitive drums with laser light. The processor 30 executes image adjustment to obtain a desired print range under operation control according to the print range with a printing reference as a start point.

The image forming unit 25 develops the electrostatic latent images formed on the photosensitive drums with toner in the respective colors according to an operation instruction from the processor 30. Furthermore, the image forming unit 25 transfers (primary transfer) toner formed on the photosensitive drums to the intermediate transfer belt.

The transfer unit 28 transfers (secondary transfers) the toner images transferred to the intermediate transfer belt 27 to the paper according to an operation instruction from the processor 30. The fixing device 29 rotates/moves the heat roller 29b and the press roller 29c according to an operation instruction from the processor 30. The heater 29a of the fixing device 29 increases a surface temperature of the heat roller 29b to a desired fixation temperature under the control of the processor 30. The fixing device 29 fixes the toner images to the paper while being controlled to the fixation temperature.

Next, a configuration example of a control system in the operation panel 14 will be described.

As illustrated in FIG. 4, the operation panel 14 has the processor 40, a memory 41, the display unit (display) 42, the touch panel 43, the operation buttons 44, and the like.

The processor 40 realizes various functions by executing a program stored in the memory 41. For example, the processor 40 performs operation control of each unit of the operation panel 14, monitoring of an operation situation of each unit, and the like by executing the program. Furthermore, the processor 40 is connected to the processor 50 of the system control unit 15 via the interface. For example, the processor 40 notifies the system control unit 15 of information input from the user.

The memory 41 includes a random access memory (RAM), a read only memory (ROM), and a data memory. The RAM functions as a working memory or a buffer memory. The ROM is a non-rewritable nonvolatile memory. The ROM functions as a program memory. The data memory is a rewritable nonvolatile memory.

The information displayed (display content) on the display unit 42 is controlled according to an operation instruction from the processor 40. The touch panel 43 is provided on the display screen of the display unit 42 and detects a touched position on the display screen. For example, the processor 40 displays icons, which can be selected on the touch panel 43, along with an operation guide on the display screen of the display unit 42. The processor 40 determines which information has been input from the user according to a touch position detected by the touch panel 43. The operation buttons 44 can be configured as hardware keys, such as a start key and a reset key.

Next, a configuration example of a control system in the RFID device 16 (reader-writer) of the digital multifunction peripheral 3 according to the embodiment will be described.

As illustrated in FIG. 4, the RFID device 16 has the processor 60, a memory 61, a communication control circuit 62, and an antenna 63.

The processor 60 realizes various functions by executing a program stored in the memory 61. For example, the processor 60 performs operation control of each unit in the RFID device 16 by executing the program. Furthermore, the processor 60 is connected to the processor 50 of the system control unit 15 via the interface. The processor 60 executes a command process, such as transmission of a command to the RFID tag and a processing of a response from the RFID tag according to an operation instruction from the system control unit 15.

The memory 61 includes a random access memory (RAM), a read only memory (ROM), and a data memory. The RAM functions as a working memory or a buffer memory. The ROM is a non-rewritable nonvolatile memory. The ROM functions as a program memory. The data memory is a rewritable nonvolatile memory.

The communication control circuit 62 processes signals that are transmitted from and received by the antenna 63. The communication control circuit 62 is connected to the processor 60 and the antenna 63. The communication control circuit 62 has, for example, a modulation circuit, an amplification circuit, an output setting circuit, a demodulation circuit, and the like.

The antenna 63 transmits and receives radio waves. The antenna 63 is connected to the communication control circuit 62. The antenna 63 transmits a signal from the communication control circuit 62 as radio waves. Furthermore, the antenna 63 supplies signals received as radio waves to the communication control circuit 62.

For example, the communication control circuit 62 transmits a signal from the antenna 63 as radio waves. The communication control circuit 62 modulates the signal from the processor 60 using the modulation circuit, amplifies the modulated signal using the amplification circuit, and outputs the amplified signal from the antenna 63 as radio waves. Accordingly, the processor 60 writes data to the RFID tag of the medium (at the write position) via the antenna 63 according to an output signal output from the communication control circuit 62.

The communication control circuit 62 processes the radio waves received by the antenna 63 and supplies the processed ratio wave signal to the processor 60. The communication control circuit 62 amplifies a radio wave signal received by the antenna 63 using the amplification circuit, demodulates the amplified signal using the demodulation circuit, and supplies the demodulated signal to the processor 60. Accordingly, the processor 60 communicates with the RFID tag (or other electronic device) of the medium passing the communication range through using the communication control circuit 62 and the antenna 63.

Next, a configuration of a control system in the terminal apparatus 4 in the image forming system 1 according to the embodiment will be described.

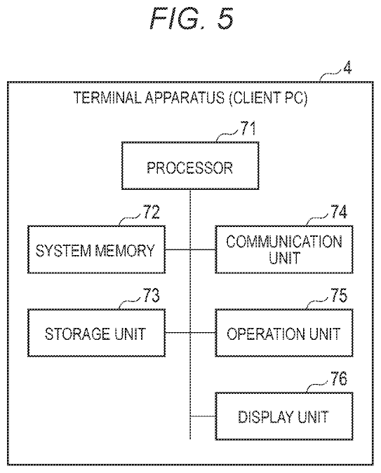

FIG. 5 is a block diagram illustrating a configuration example of the control system in the terminal apparatus 4 in the image forming system 1.

The terminal apparatus 4 has a processor 71, a system memory 72, a storage unit 73, a communication unit 74, an operation unit 75, a display unit 76, and the like.

The processor 71 is connected to the system memory 72, the storage unit 73, and the communication unit 74. The processor 71 realizes various functions by executing a program stored in the system memory 72 or the storage unit 73. For example, the processor 71 executes the program stored in the system memory 72, thereby outputting an operation instruction to each unit or processing various kinds of information from each unit.

The system memory 72 includes a random access memory (RAM), a read only memory (ROM), and an NVM. The RAM functions as a working memory or a buffer memory. The ROM is a non-rewritable nonvolatile memory. The ROM functions as a program memory. The NVM is a rewritable nonvolatile memory. The NVM stores setting data and the like.

The storage unit 73 stores data, such as control data, a control program, and setting information. The storage unit 73 is configured with a rewritable nonvolatile memory. For example, the storage unit 73 is configured with a storage device, such as a hard disk drive (HDD) or a solid-state drive (SSD).

The communication unit 74 is a communication interface for communicating with an external apparatus. For example, the communication unit 74 is a communication interface for network communication. In the image forming system 1, the communication unit 74 communicates with the digital multifunction peripheral 3 and the RFID device 16 via the network 6. Furthermore, the communication unit 74 may be a communication unit including an interface for a serial type connection to the digital multifunction peripheral 3.

The operation unit 75 is equipment that can be operated (manipulated) by the user, such as a keyboard or a touch panel. The display unit 76 is a display device that displays information. For example, the operation unit 75 and the display unit 76 may be configured as a touch panel-equipped display device. For example, the user designates an image to be printed on each page and an RFID command to an RFID tag of each page using the operation unit 75. The processor 71 creates print data including the image for each page and the command to the RFID tag for each page designated by using the operation unit 75.

Next, print data that is input to the digital multifunction peripheral 3 will be described.

In the image forming system 1 according to the present embodiment, the digital multifunction peripheral 3 acquires the print data including a command (RFID command) for the RFID tag from the terminal apparatus 4 or the like. The digital multifunction peripheral 3 acquires the print data including the image to be printed on each page and the command for the RFID tag of each page.

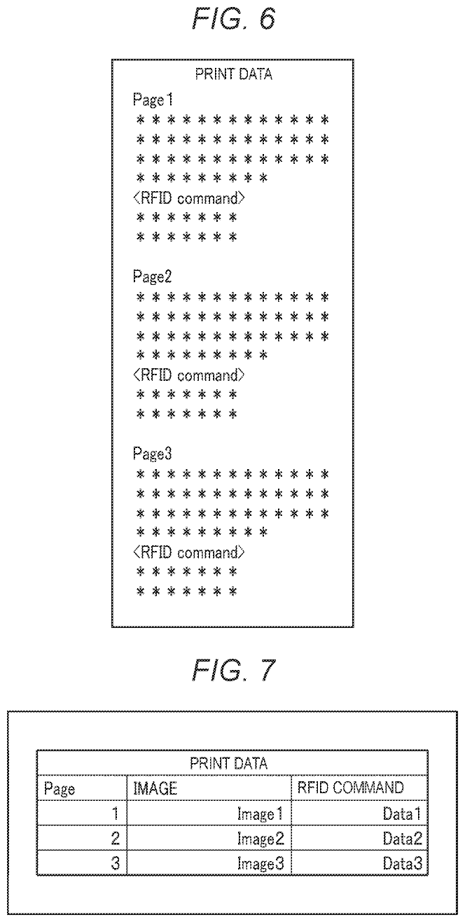

FIG. 6 is a diagram illustrating an example of print data that is supplied to the digital multifunction peripheral 3. FIG. 7 is an example of a table in which drawing data of each page and a command (command data) for each page as included in print data are stored in association with each other.

In an embodiment, as illustrated in FIG. 6, the command (RFID command) for the RFID tag is embedded in the print data rather than separately provided. The print data as illustrated in FIG. 6 is generated by the terminal apparatus 4. On the terminal apparatus 4, a program (a client application) associated with the digital multifunction peripheral 3 is installed. The client application that is installed on the terminal apparatus 4 has a function of generating the print data including (incorporating) a RFID command for controlling operations of an RFID device (reader-writer) installed in or attached to the digital multifunction peripheral 3.

The processor 71 of the terminal apparatus 4 creates print data including a RFID command, such as illustrated in FIG. 6, by executing the client application. The print data illustrated in FIG. 6 is comprised of print data for multiple pages (three pages). In the print data of each page, an image to be printed on one page (that is, drawing data for a page) and an RFID command for an RFID tag of the page are both included. The terminal apparatus 4 transmits the print data including the RFID command as generated by the client application to the digital multifunction peripheral 3.

The digital multifunction peripheral 3 receives the print data including the RFID command from the terminal apparatus 4. The digital multifunction peripheral 3 executes a detection process of detecting the RFID command included the print data received from the terminal apparatus 4. If RFID commands are included in the print data, the digital multifunction peripheral 3 extracts the RFID command for each page. The digital multifunction peripheral 3 stores the drawing data and the RFID command for each page in the memory in association with each other.

FIG. 7 illustrates an example of a table in which the drawing data (IMAGE) of each page and the RFID command of each page are stored in association with each other.

For example, the digital multifunction peripheral 3 extracts “Image1” as drawing data from print data for a first page and extracts “Data1” as an RFID command for the first page. As illustrated in FIG. 7, the digital multifunction peripheral 3 stores the drawing data “Image1” and the RFID command “Data1” in association with each other as data of the first page.

The digital multifunction peripheral 3 extracts “Image2” as drawing data from print data for a second page and extracts “Data2” as an RFID command for the second page. As illustrated in FIG. 7, the digital multifunction peripheral 3 stores the drawing data “Image2” and the RFID command “Data2” in association with each other as data of the second page.

The digital multifunction peripheral 3 also extracts “Image3” as drawing data from print data for a third page and extracts “Data3” as an RFID command for the third page. As illustrated in FIG. 7, the digital multifunction peripheral 3 stores the drawing data “Image3” and the RFID command “Data3” in association with each other as data of the third page.

That is, the digital multifunction peripheral 3 extracts the RFID commands for each page from the print data illustrated in FIG. 6. After the RFID commands are extracted for each page, the digital multifunction peripheral 3 creates a table illustrated in FIG. 7 in which the drawing data and the RFID command are associated with each other for each page. Accordingly, the digital multifunction peripheral 3 can manage the drawing data and the RFID command of each page included in one piece of print data in association with each other reliably.

Next, a generation process of print data including an RFID command by the terminal apparatus 4 will be described.

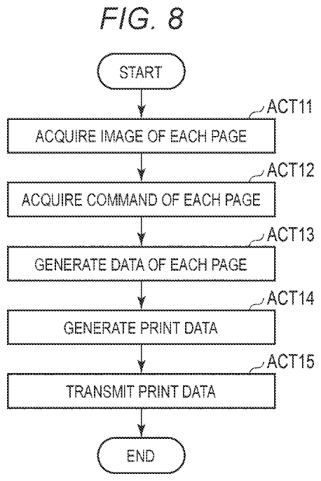

FIG. 8 is a flowchart of a generation of print data including an RFID command by the terminal apparatus 4.

First, the user starts the client application on the terminal apparatus 4. The processor 71 of the terminal apparatus 4 may receive designation of process content for an RFID tag of each page in a print setting instructed by the user. For example, the processor 71 displays a print setting screen on the display unit 76 and receives designation of process content for the RFID tag for each page on the print setting screen. The user designates the process contents for the RFID tag for each page using the operation unit 75 while the print setting screen is displayed on the display unit 76.

The processor 71 may receive a designation of data (RFID data) to be written to the RFID tag for each page. For example, the user may select writing of data to the RFID tag for each page and may designate data to be written to the RFID tag of each page. In addition, 71 may receive the designation for automatic generation of data to be written to the RFID tag of each page. If the user instructs automatic generation of RFID data, the processor 71 generates data (RFID data) to be written to the RFID tag of each page (e.g., for example, as a fixed or incremental sequence).

When the user designates that an image is to be printed, the processor 71 acquires the designated image for drawing data of each page (ACT11). For example, the processor 71 converts image data to be printed into drawing data in an image data format suitable for printing. The processor 71 stores the drawing data for each page as image data for printing in the system memory 72.

After the user designates process content for the RFID tag for each page, the processor 71 acquires an RFID command for each page based on the designated process contents (ACT12). For example, after data (RFID data) to be written to the RFID tag is designated, the processor 71 generates a command (write command) that requests writing of the data to the RFID tag. That is, when the RFID data for a page is acquired, the processor 71 generates a write command in which the RFID data for the page is set. If a reading of data from the RFID tag is designated, the processor 71 generates a command (read command) that requests a reading of data from the RFID tag.

After the drawing data of each page and the RFID command of each page are acquired, the processor 71 generates print data for each page (ACT13). The processor 71 associates the drawing data and the RFID command for each page and generates the print data of each page. The generated print data for each page includes the drawing data of the page and the RFID command for the page.

Once the print data of each page is generated, the processor 71 next generates print data (e.g., as a print job) in which the print data of the separate pages can be coupled (ACT14). For example, as illustrated in FIG. 7, the processor 71 creates print data in which the print data of the different pages is coupled together in a page order (print order). Once this print data is created, the processor 71 transmits the created print data to the digital multifunction peripheral 3 (ACT15).

With the above process, the terminal apparatus 4 can generate print data in which commands and data for s RFID tag is incorporated in the print data by page and transmit the generated print data (with embedded RFID commands/data) to the digital multifunction peripheral 3.

Next, printing according to print data including a RFID command by the digital multifunction peripheral 3 will be described.

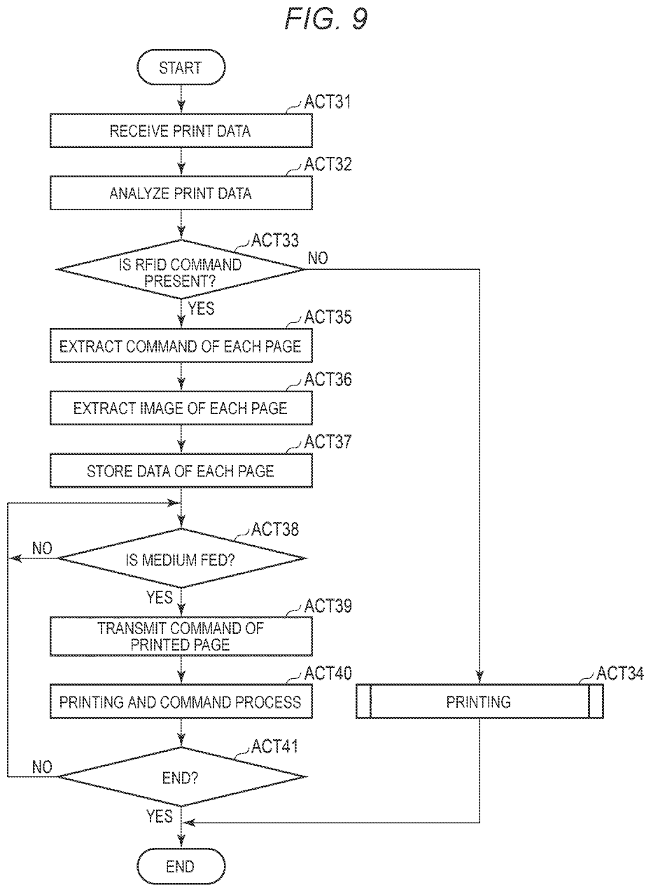

FIG. 9 is a flowchart illustrating an example of a processing of the print data including a RFID command by the digital multifunction peripheral 3.

The system control unit 15 receives the print data from the terminal apparatus 4 or the like via the network 6 through the communication interface 55 (ACT31). The processor 50 of the system control unit 15 stores the print data received from the terminal apparatus 4 in a memory, such as the memory 51 or the storage device 54. Once the print data is stored in the memory, the processor 50 analyzes the received print data (ACT32).

Here, the processor 50 executes an analysis process including a detection process for detecting RFID commands in the print data. The detection process may be a process of detecting the RFID commands embedded in the print data. For example, the processor 50 detects a command by detecting code data for the RFID command for the RFID tag in the print data. Alternatively, the processor 50 may detect the RFID command by performing character recognition looking for a particular character string included in the print data and detecting the character string representing a RFID command.

If the RFID command is not included in the print data (ACT33, NO), the processor 50 executes printing based on the drawing data in the print data (ACT34). For example, the processor 50 supplies the drawing data to the printer 13. The printer 13 executes printing of each page based on the drawing data for each page as supplied from the processor 50.

If a RFID command is detected in the print data (ACT33, YES), the processor 50 extracts the RFID command from the print data (ACT35). The processor 50 also extracts the drawing data (page image data) from the print data for each page (ACT36).

After the drawing data and the RFID command of each page are extracted, the processor 50 stores the drawing data and the RFID command in association with each other for each page (ACT37). For example, the processor 50 creates the table as illustrated in FIG. 7. The processor 50 stores the table in a memory, such as the memory 51 or the storage device 54.

Once the drawing data and the RFID command are stored in association with each other for each page, the processor 50 feeds the sheet (medium) including a RFID tag in an appropriate page order. For example, the processor 50 supplies the drawing data to the printer 13 in a page order to instruct printing of each page in the print job or the like. The printer 13 feeds the sheets with a RFID tag one by one in response to an instruction of the processor 50.

When the printer 13 feeds one sheet (ACT38, YES), the processor 50 next operates to cause the RFID command to be performed for the RFID tag of the sheet being fed by the printer 13 by the RFID device 16 (ACT39). The processor 50 supplies the RFID command associated with the drawing data of the corresponding sheet to the RFID device 16 and also provides a print instruction to the printer 13 for the sheet. Accordingly, the drawing data is printed on the sheet by the printer 13 and the RFID command is supplied to the RFID device 16 and these reliably match each other.

The processor 50 monitors printing of the drawing data by the printer 13 and the execution of the RFID command by the RFID device 16 (ACT40). For example, the processor 50 conveys the sheet with the RFID tag to the communication position of the RFID device 16 using the conveyance system 23 of the printer 13. The RFID device 16 executes a command process for supplying the RFID command to the RFID tag of the sheet at the communication position. Once the command process of the RFID device 16 is completed, the processor 50 then executes printing on the sheet by controlling the printer 13.

When the command process and printing for every page are completed, the processor 50 next determines whether to end the processing (ACT41). For example, the processor 50 determines whether to end processing according to whether there is still a remaining page to be printed. If there is another page still to be printed/written, that is, if the processing for the print job does not end (ACT41, NO), the processor 50 returns to ACT38, and executes printing and the command process for the next page. If no unprocessed page remains, that is, if the print job is done (ACT41, YES), the processor 50 ends the processing.

As described above, an image forming apparatus according to an embodiment extracts a RFID command from print data. The image forming apparatus stores the drawing data and the RFID command for each page as extracted from the print data. The extracted drawing data and the RFID are stored in association with each other. The image forming apparatus executes printing of each page and the RFID command processing for the page based on the data stored in the memory.

Accordingly, an image forming apparatus according to an embodiment can extract drawing data and a RFID command for each page from the print data. As a result, the image forming apparatus can better match the image printed on each page to RFID information to be associated with the printed page.

While certain embodiments have been described, these embodiments have been presented by way of example only, and are not intended to limit the scope of the inventions. Indeed, the novel embodiments described herein may be embodied in variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image forming apparatus, comprising:
a printer configured to print images on media;
a tag reader-writer configured to communicate with wireless tags on the media;
a communication interface configured to communicate with an external apparatus; and
a processor configured to:
receive print data via the communication interface from the external apparatus,
extract a tag reader-writer command from the received print data,
control the printer to print an image on a medium according to drawing data in the received print data, and
control the tag reader-writer according to the extracted tag reader-writer command to perform an operation on a wireless tag on the medium.

2. The image forming apparatus according to claim 1, wherein the tag reader-writer is an RFID tag reader-writer device.

3. The image forming apparatus according to claim 1, wherein the wireless tag is an RFID tag.

4. The image forming apparatus according to claim 1, further comprising:
a memory unit for storing data, wherein
the media is sheets of paper,
the print data includes drawing data for multiple sheets, and
the processor is configured to store, in the memory unit, drawing data for each sheet in the print data in association with the extracted tag reader-writer command for the sheet.

5. The image forming apparatus according to claim 4, wherein the extracted tag reader-writer command is a command to write page-specific data to the wireless tag on the sheet.

6. The image forming apparatus according to claim 1, wherein the extracted tag reader-writer command is a command to write data to the wireless tag on the medium.

7. The image forming apparatus according to claim 1, wherein
the tag-reader writer command is encoded in the print data, and
the processor is configured to identify the tag reader-writer command in the received print data according to a coding of the tag reader-writer command.

8. The image forming apparatus according to claim 1, wherein
the tag-reader writer command is represented as a character string in the print data, and
the processor is configured to identify the tag reader-writer command in the received print data according to detection of the character string in the print data.

9. A multifunctional peripheral device, comprising:
a scanner configured to scan documents;
a printer configured to print images on sheets of paper;
a tag reader-writer configured to communicate with wireless tags on the sheets;
a communication interface configured to communicate with an external apparatus; and
a processor configured to:
receive print data via the communication interface from the external apparatus,
extract a tag reader-writer command from the received print data,
control the printer to print an image on a sheet according to drawing data in the received print data, and
control the tag reader-writer according to the extracted tag reader-writer command to perform an operation on a wireless tag on the sheet.

10. The multifunctional peripheral device according to claim 9, wherein the tag reader-writer is an RFID tag reader-writer device.

11. The multifunctional peripheral device according to claim 9, wherein the wireless tag is an RFID tag.

12. The multifunctional peripheral device according to claim 9, further comprising:
a memory unit for storing data, wherein
the print data includes drawing data for multiple sheets, and
the processor is configured to store, in the memory unit, drawing data for each sheet in the print data in association with the extracted tag reader-writer command for the sheet.

13. The multifunctional peripheral device according to claim 12, wherein the extracted tag reader-writer command is a command to write page-specific data to the wireless tag on the sheet.

14. The multifunctional peripheral device according to claim 9, wherein the extracted tag reader-writer command is a command to write data to the wireless tag on the sheet.

15. The multifunctional peripheral device according to claim 9, wherein
the tag-reader writer command is encoded in the print data, and
the processor is configured to identify the tag reader-writer command in the received print data according to a coding of the tag reader-writer command.

16. The multifunctional peripheral device according to claim 9, wherein
the tag-reader writer command is represented as a character string in the print data, and
the processor is configured to identify the tag reader-writer command in the received print data according to detection of the character string in the print data.

17. A method for an image forming apparatus including a tag reader-writer, the method comprising:
receiving print data via a communication interface from an external apparatus;
extracting a tag reader-writer command from the received print data;
controlling a printer to print an image on a medium according to drawing data in the received print data; and
control a tag reader-writer according to the extracted tag reader-writer command to perform an operation on a wireless tag on the medium.

18. The method according to claim 17, wherein the tag reader-writer is an RFID tag reader-writer device.

19. The method according to claim 17, wherein the wireless tag is an RFID tag.

20. The method according to claim 17, wherein
the media is sheets of paper,
the print data includes drawing data for multiple sheets, and
the method further comprises:
storing drawing data for each sheet in the print data in association with the extracted tag reader-writer command for the sheet.
